(19) United States
(12) Patent Application Publication
(10) Pub. No.: US 2025/0047659 A1
(43) Pub. Date: Feb. 6, 2025

(54) Type-Based Authentication of Edge Enabler Client (EEC)

(71) Applicant: Telefonaktiebolaget LM Ericsson (publ), Stockholm (SE)

(72) Inventors: Christine Jost, Dalby (SE); Cheng Wang, Shanghai (CN); Ferhat Karakoc, Istanbul (TR); Vlasios Tsiatsis, Stockholm (SE); Wenliang Xu, Shanghai (CN)

(21) Appl. No.: 18/705,244

(22) PCT Filed: Oct. 28, 2022
(86) PCT No.: PCT/EP2022/080189

§ 371 Date: Apr. 26, 2024

(30) Foreign Application Priority Data
Nov. 1, 2021 (WO) PCT/CN2021/127894

(51) Int. Cl. H04L 9/40

(52) U.S. Cl. CPC H04L 63/0823; H04L 63/166

(57) ABSTRACT

Embodiments of the present disclosure include methods for a client in an edge data network. Such methods include obtaining an initial access credential before accessing the edge data network. The initial access credential includes or is based on one or more of the following: an indication that the client is a legitimate client, and a client type associated with the client. Such methods include establishing a first connection with a server of the edge data network based on transport layer security (TLS); authenticating the server via the first connection based on a server certificate; and providing the initial access credential to the server, via the first connection, for authentication of the client. Other embodiments include complementary methods for a server and for a credential provider, as well as UEs, network nodes, and/or computing systems configured to perform such methods.

### TECHNICAL FIELD

The present disclosure relates generally to the field of wireless communication networks, and more specifically to “edge computing” techniques that facilitate execution environments proximate to users and/or devices that provide and consume data, rather than in centralized, public network clouds.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases.

These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation RAN (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an “AMF Region”, with the term “AMF” being described in more detail below. The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions. As such, each of the CUs and DUs can include various circuitry needed to perform their respective functions, including processing circuitry, transceiver circuitry (e.g., for communication), and power supply circuitry.

A gNB-CU connects to one or more gNB-DUs over respective F1 logical interfaces, such as interfaces 122 and 132 shown in FIG. 1. However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services. This SBA model also adopts principles like modularity, reusability, and self-containment of NFs, which can enable deployments to take advantage of the latest virtualization and software technologies.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context.

3GPP Rel-16 introduced a feature called authentication and key management for applications (AKMA) that is based on 3GPP user credentials in 5G, including the Internet of Things (IoT) use case. More specifically, AKMA leverages the user's AKA (Authentication and Key Agreement) credentials to bootstrap security between the UE and an application function (AF), which allows the UE to securely exchange data with an application server. The AKMA architecture can be considered an evolution of GBA (Generic Bootstrapping Architecture) specified for 5GC in 3GPP Rel-15 and is further specified in 3GPP TS 33.535 (v16.0.0).

It is expected that 5GC will support edge computing (EC), which enables operator and third-party services to be hosted close to a UE's access point of attachment. This can facilitate efficient service delivery through the reduced end-to-end latency and load on the transport network. The 5GC can select a user plane function (UPF) close to the UE and executes the traffic steering from the UPF to the local Data Network via an N6 interface. Both UPF and N6 are discussed in more detail below.

3GPP TR 23.748 (v17.0.0) discusses architectural enhancements that may be needed to support EC in 5GC for 3GPP Rel-17. In addition, 3GPP TR 33.839 (v0.7.0) discusses a study on security aspects of enhancement of support for EC in 5GC for 3GPP Rel-17. Key issues discussed in 3GPP TR 33.839 (v0.7.0) include authentication, authorization, and transport security solutions for interfaces between clients and servers and for interfaces between different servers in an Edge data network. These servers can include Edge Configuration Servers (ECS), Edge Enabler Servers (EES), and Edge Application Servers (EAS). Relevant clients include Edge Enabler Client (EEC), which can be regarded an application that runs on the UE and communicates with the ECS and EES.

Various solutions to these and other issues are discussed in 3GPP TR 33.839 (v0.7.0), and further solutions have been proposed in the development of normative 3GPP standards for Edge Computing security (e.g., in 3GPP SA3).

### SUMMARY

However, current solutions for EEC authentication have various difficulties, issues, and/or drawbacks. For example, many of these solutions rely on authentication of an identifier of the EEC (EEC ID), which adds unnecessary complexity to the authentication process.

Accordingly, embodiments of the present disclosure address these and other problems, issues, and/or difficulties related to security, thereby enabling the otherwise-advantageous deployment of EC solutions in relation to a 5G network.

Some embodiments of the present disclosure include methods (e.g., procedures) for a client (e.g., EEC) in an edge data network (e.g., 5G network).

These exemplary methods can include obtaining an initial access credential before access the edge data network. The initial access credential includes or is based on one or more of the following: an indication that the client is a legitimate client, and a client type associated with the client. In some embodiments, the initial access credential also includes or is further based on an identifier of the client. These exemplary methods can also include establishing a first connection with a server of the edge data network based on transport layer security (TLS). These exemplary methods can also include authenticating the server via the first connection based on a server certificate. These exemplary methods can also include providing the initial access credential to the server, via the first connection, for authentication of the client.

In some embodiments, these exemplary methods can also include, after authentication of the client based on the initial access credential, receiving a second access credential from the server via the first connection. The second access credential includes or is based on one or more of the following: the indication that the client is a legitimate client, the client type associated with the client, and an identifier of the client.

In some of these embodiments, these exemplary methods can also include establishing a second connection with the server based on TLS; authenticating the server via the second connection based on a server certificate; and providing the second access credential to the server, via the second connection, for authentication of the client. In some variants, these exemplary methods can also include, after authentication of the client based on the second access credential, receiving a third access credential from the server via the second connection. The third access credential includes or is based on one or more of the following: the indication that the client is a legitimate client, the client type associated with the client, and the identifier of the client.

In some embodiments, the client is an Edge Enabler Client (EEC) and the initial access credential is obtained from an edge computing service provider (ECSP) that is associated with the EEC. In some of these embodiments, these exemplary methods can also include the following operations: after expiration of a most recently obtained access credential (e.g., initial, second, or third), sending to the ECSP a request for an updated access credential, receiving the updated access credential from the ECSP in response to the request, and providing the updated access credential to the server, via a next-established connection (i.e., next connection established with the server), for authentication of the EEC. In some variants, the updated access credential includes or is based on one or more of the following: the indication that the client is a legitimate client, and the client type associated with the client.

In various embodiments, the server is an ECS or an EES.

Other embodiments include complementary methods (e.g., procedures) for a server (e.g., ECS, EES) in an edge data network (e.g., 5G network).

These exemplary methods can include establishing a first connection with a client of the edge data network based on TLS. These exemplary methods can also include providing a server certificate to the client, via the first connection, for authentication of the server. These exemplary methods can also include authenticating the client based on an initial access credential received from the client via the first connection. The initial access credential includes or is based on one or more of the following: an indication that the client is a legitimate client, and a client type associated with the client. In some embodiments, the initial access credential also includes or is further based on an identifier of the client.

In some embodiments, these exemplary methods can also include, after authentication of the client based on the initial access credential, sending a second access credential to the client via the first connection. The second access credential includes or is based on one or more of the following: the indication that the client is a legitimate client, the client type associated with the client, and the identifier of the client.

In some of these embodiments, these exemplary methods can also include establishing a second connection with the client based on TLS; providing the server certificate to the client, via the second connection, for authentication of the server; and authenticating the client based on the second access credential received from the client via the second connection.

In some of these embodiments, these exemplary methods can also include, after authentication of the client based on the second access credential, selectively sending a third access credential to the client via the second connection. The third access credential includes or is based on one or more of the following: the indication that the client is a legitimate client, the client type associated with the client, and the identifier of the client.

In some variants, selectively sending can include comparing a duration of validity of the second access credential to a predetermined threshold; sending the third access credential when the duration of validity is less than the predetermined threshold; and refraining from sending the third access credential when the duration of validity is not less than the predetermined threshold.

In some embodiments, the initial access credential is obtained by the client from a credential provider other than the server and the authenticating operations can include the following sub-operations: validating the initial access credential based on one of the following: a certificate of the credential provider, a public key of the credential provider, or by contacting the credential provider; and verifying one or more of the following based on the initial access credential: that the client is a legitimate client, and that the client type associated with the client is a legitimate client type.

In some embodiments, these exemplary methods can also include, after expiration of at least the initial access credential, authenticating the client based on an updated access credential received from the client. Like the initial access credential, the updated access credential includes or is based on one or more of the following: an indication that the client is a legitimate client, and a client type associated with the client.

In some of these embodiments, these exemplary methods can also include authorizing the client to access the server based on at least one of the following: the initial access credential, and the updated access credential. In some of these embodiments, the client is an EEC and the initial access credential and the updated access credential are obtained by the EEC from an ECSP associated with the EEC. In various embodiments, the server is an ECS or an EES.

Other embodiments include complementary methods (e.g., procedures) for a credential provider (e.g., ECSP) associated with an edge data network (e.g., 5G network).

These exemplary methods can include providing a client in the edge data network an initial access credential for a server in the edge data network, before the client accesses the server. These exemplary methods can also include receiving from the client a request for an updated access credential for the server. These exemplary methods can also include sending the updated access credential to the client in response to the request. The initial access credential and the updated access credential include or are based on one or more of the following: an indication that the client is a legitimate client, and a client type associated with the client. In some embodiments, at least one of the initial access credential and the updated access credential also includes or is further based on an identifier of the client.

In some embodiments, the client is an EEC and the credential provider is an ECSP associated with the EEC.

Other embodiments include clients, servers, and credential providers for an edge data network (or network nodes or computing systems hosting the same) that are configured to perform the operations corresponding to any of the exemplary methods described herein. Other embodiments also include non-transitory, computer-readable media storing computer-executable instructions that, when executed by processing circuitry, configure such clients, servers, and credential providers to perform operations corresponding to any of the exemplary methods described herein.

These and other embodiments described herein can facilitate authentication of EEC based on a credential issued by the ECSP, which can be based on other information than EEC ID. This simplifies EEC authentication and facilitates secure deployment of edge computing within 5G networks.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows a diagram of an exemplary application-layer architecture supporting edge computing (EC) applications in a 5G network.

FIG. 4 shows an exemplary signal flow diagram of a technique for authentication of an Edge Enabler Client (EEC) by an Edge Configuration Server (ECS) and an Edge Enabler Server (EES).

FIG. 5 shows a signal flow diagram of a token-based solution for EES onboarding.

FIGS. 6-14 show signal flow diagrams of various proposed techniques for authentication and authorization between EEC and either ECS or EES.

FIGS. 15-16 show signal flow diagrams of techniques for authenticating an EEC towards an ECS and an ECS, respectively, according to various embodiments of the present disclosure.

FIG. 17 shows an exemplary method (e.g., procedure) for a client in an edge data network, according to various embodiments of the present disclosure.

FIG. 18 shows an exemplary method (e.g., procedure) for a server in an edge data network, according to various embodiments of the present disclosure.

FIG. 19 shows an exemplary method (e.g., procedure) for a credential provider associated with an edge data network, according to various embodiments of the present disclosure.

FIG. 20 shows a communication system according to various embodiments of the present disclosure.

FIG. 21 shows a UE according to various embodiments of the present disclosure.

FIG. 22 shows a network node according to various embodiments of the present disclosure.

FIG. 23 shows host computing system according to various embodiments of the present disclosure.

FIG. 24 is a block diagram of a virtualization environment in which functions implemented by some embodiments of the present disclosure may be virtualized.

FIG. 25 illustrates communication between a host computing system, a network node, and a UE via multiple connections, at least one of which is wireless, according to various embodiments of the present disclosure.

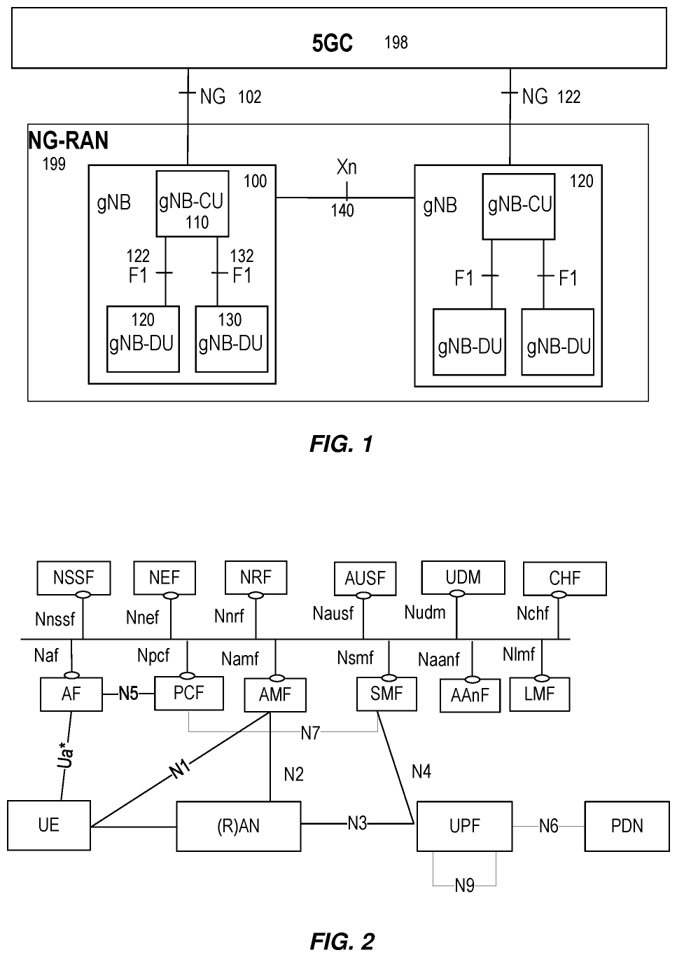

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the disclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, mobile terminals (MTs), etc.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device.
Service: As used herein, the term “service” refers generally to a set of data, associated with one or more applications, that is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, as such, concepts described herein apply equally to both cells and beams.

As briefly mentioned above, current solutions for Edge Enabler Client (EEC) authentication—such as AKMA and transport layer security (TLS)—have various difficulties, issues, and/or drawbacks that make them unsuitable for use over interfaces between EEC and various servers (e.g., ECS and/or EES) in the proposed Edge network for the 5GS. This can create various problems, difficulties, and/or issues for deployment of EC solutions, which is discussed in more detail after the following description of 5G network and security architectures.

FIG. 2 shows an exemplary non-roaming 5G reference architecture with service-based interfaces and various 3GPP-defined NFs within the Control Plane (CP). These include the following NFs, with additional details provided for those most relevant to the present disclosure:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.
Unified Data Management (UDM) function with Nudm interface—supports generation of 3GPP authentication credentials, user identification handling, access authorization based on subscription data, and other subscriber-related functions. To provide this functionality, the UDM uses subscription data (including authentication data) stored in the 5GC unified data repository (UDR), which also supports storage and retrieval of policy data by the PCF, as well as storage and retrieval of application data by NEF.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

3GPP Rel-16 introduces a new feature called authentication and key management for applications (AKMA) that is based on 3GPP user credentials in 5G, including the Internet of Things (IoT) use case. More specifically, AKMA leverages the user's AKA (Authentication and Key Agreement) credentials to bootstrap security between the UE and an application function (AF), which allows the UE to securely exchange data with an application server. The AKMA architecture is an evolution of Generic Bootstrapping Architecture (GBA) specified for 5GC in 3GPP Rel-15 and is further specified in 3GPP TS 33.535 (v16.1.0).

In addition to the NEF, AUSF, and AF shown in FIG. 2 and described above, Rel-16 AKMA also utilizes an anchor function for authentication and key management for applications (AAnF). This function is shown in FIG. 2 with Naanf interface. In general, AAnF interacts with AUSFs and maintains UE AKMA contexts to be used for subsequent bootstrapping requests, e.g., by application functions. At a high level, AAnF is similar to a bootstrapping server function (BSF) defined for Rel-15 GBA.

In general, security mechanisms for various 5GS protocols rely on multiple security keys. 3GPP TS 33.501 (v16.4.0) specifies these keys in an organized hierarchy. At the top is the long-term key part of the authentication credential and stored in the SIM card on the UE side and in the UDM/ARPF in the user's HPLMN.

A successful Primary Authentication run between the UE and the AUSF in the HPLMN leads to the establishment of K_{AUSF}, the second level key in the hierarchy. This key is not intended to leave the HPLMN and is used to secure the exchange of information between UE and HPLMN, such as for the provisioning of parameters to the UE from UDM in HPLMN.

More precisely, K_{AUSF} is used for integrity protection of messages delivered from HPLMN to UE. As described in 3GPP TS 33.501 (v16.4.0), such new features include the Steering of Roaming (SoR) and the UDM parameter delivery procedures.

K_{AUSF} is used to derive another key, K_{SEAF}, that is sent to the serving PLMN. This key is then used by the serving PLMN to derive subsequent NAS and AS protection keys. These lower-level keys together with other security parameters (e.g., cryptographic algorithms, UE security capabilities, value of counters used for replay protection in various protocols, etc.) constitute the 5G security context as defined in 3GPP TS 33.501 However, K_{AUSF} is not part of the UE's 5G security context that resides in the UE's serving PLMN.

3GPP TR 33.839 (v0.7.0) discusses a study on security aspects of enhancement of support for Edge Computing (EC) in 5GC for 3GPP Rel-17. Key issues discussed in 3GPP TR 33.839 (v0.7.0) include authentication, authorization, and transport security solutions for interfaces between clients and servers and for interfaces between different servers in an Edge data network. These servers can include Edge Configuration Servers (ECS), Edge Enabler Servers (EES), and Edge Application Servers (EAS). Relevant clients include Edge Enabler Client (EEC), which can be regarded an application that runs on the UE and communicates with the ECS and EES.

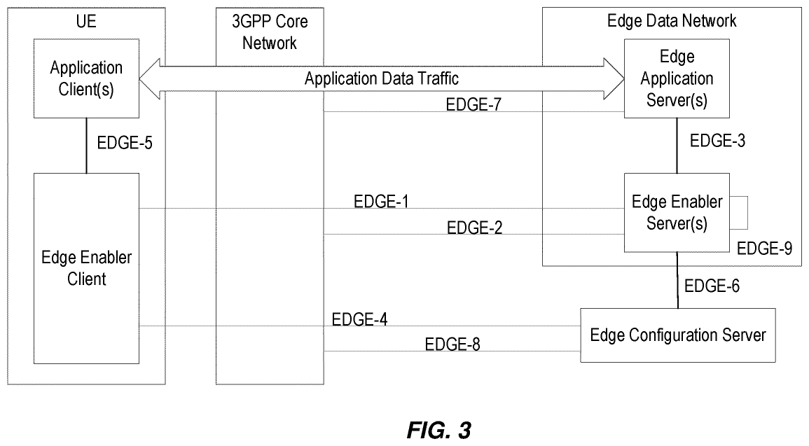

3GPP TS 23.558 (v17.1.0) specifies the various client/server and server/server interfaces in the Rel-17 EC architecture. FIG. 3 shows a diagram of an exemplary application-layer architecture supporting EC applications. In addition to the ECS, EES, EAS, and EEC mentioned above, FIG. 3 also shows one or more application clients that run on the UE and communicate application data traffic with the EAS in the Edge Data Network. Additionally, FIG. 3 shows the following client/server and server/server interfaces defined in 3GPP TS 23.558 (v17.1.0):
EDGE-1: between EEC and EES.
EDGE-2: between EES and CN (e.g., 5GC).
EDGE-3: between EAS and EES.
EDGE-4: between EEC and ECS.
EDGE-5: between EEC and application client(s).
EDGE-6: between ECS and EES.
EDGE-7: between EAS and CN.
EDGE-8: between ECS and CN.
EDGE-9: between EES and EES.

In the architecture shown in FIG. 3, the EEC, which runs on the UE, needs to authenticate itself towards to the EES/ECS. The EEC provides a UE identifier (ID) for this purpose, as specified in 3GPP TS 23.558 (v17.1.0) clause 7.2.6. Currently, the only supported UE ID is the generic public subscription identifier (GPSI), which can be used inside and outside of 5G networks as further specified in 3GPP TS 23.501 (v17.2.0) and 23.003 (v17.3.0).

3GPP TS 23.558 (v17.1.0) also specifies a new edge enabler layer that includes the UE's EEC. In this arrangement, the UE uses an EEC ID as the client identifier on the edge enabler layer. As such, the EEC uses two different identifiers towards EES: EEC ID and UE identifier (e.g., GPSI). In other words, EES/ECS may need to authenticate two different identifiers associated with the UE.

Currently 3GPP TR 33.839 (v0.7.0) includes some proposals for the authentication of the EEC and for the authentication of GPSI by the EES/ECS. Proposals for authentication of the EEC include the following:
Based on transport layer security (TLS) certificates;
Based on AF key (K_AF) derived from AKMA, GBA, or similar procedures, and usage of this key as a Pre-Shared-Key in TLS or as a key to be used in HTTP Digest protocol;
Using secondary authentication; and
Usage of tokens.

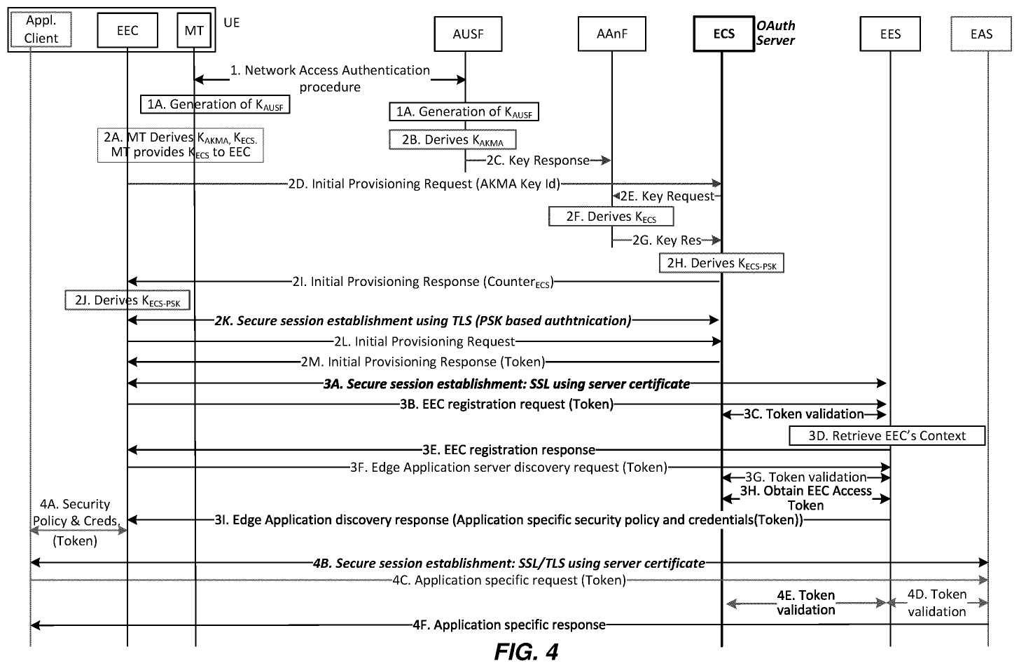

FIG. 4 shows an exemplary signal flow diagram of AKMA-based solution to address EEC authentication by ECS, which provides a token to EEC to be used for authentication with EES. A detailed description of this proposal (referred to as “solution #3”) is given in 3GPP TR 33.839 (v0.7.0) section 6.3.2, which is incorporated herein by reference in its entirety. 3GPP TR 33.839 (v0.7.0) describes a similar proposal (referred to as “solution #4) for using secondary authentication to address EEC authentication by the ECS, which provides a token to EEC to be used for authentication with EES.

3GPP TR 33.839 (v0.7.0) section 6.12.2 describes another proposal (referred to as “solution #12”) that is unrelated to authentication of EEC but uses token-based solution for EES onboarding. According to this proposal, the EES provider gives an access token to the EES, to be used for the EES onboarding. The EES sends the token to the ECS, which validates the token.

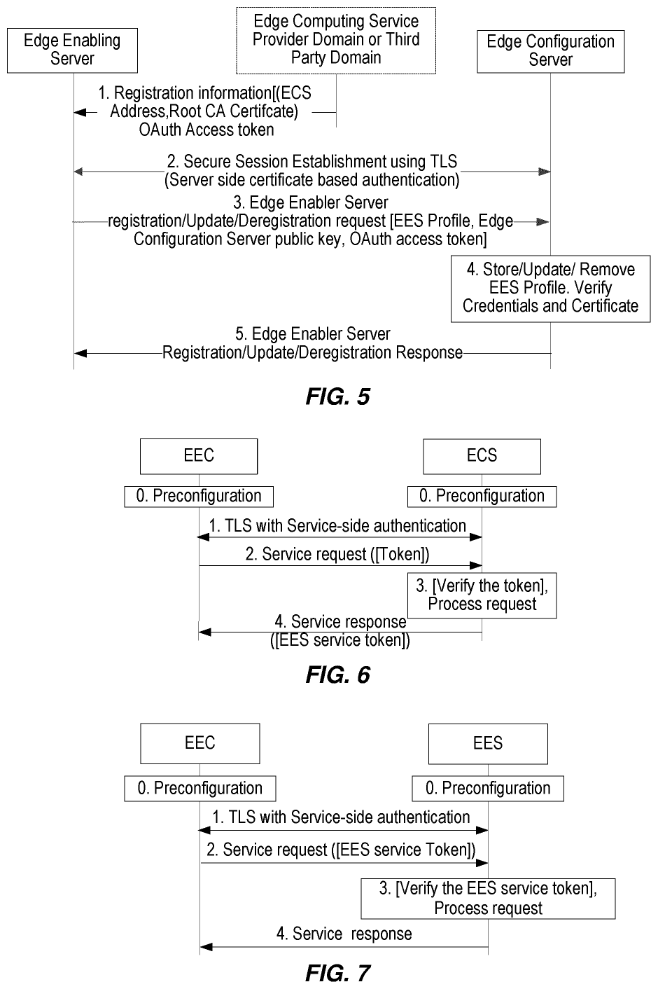

FIG. 5 shows an exemplary signal flow diagram of this proposal.

3GPP TR 33.839 (v0.7.0) describes another proposal (referred to as “solution #17”) that involves tokens provided by an edge computing service provider (ECSP) that is associated with the EEC. For the EDGE-4 interface, the authentication of the ECS and the interface transport security are realized using TLS with server based on using the server's certificate issued by CAs in the PKI. For the first authentication of the EEC by the ECS, the token, including the EEC ID, provided by the ECSP of the EEC or by a trusted new entity (that could or could not be collocated with the ECSP) to the EEC is used. In the case of provisioning of a token by ECSP, it is assumed that there is a business relationship between the ECSPs of the EEC and ECS, whereby ECSP of the EEC provisions an initial access token to the EEC, and the ECS can verify that token. After EEC authentication, the ECS provides a token to the EEC in the initial access to be used for the next establishment of the communication between them. In the subsequent accesses after the initial access, the ECS decides on whether a new access token is necessary or not, considering information such as the expiration time of the token.

For the EDGE-1 interface, the authentication of the EES and the interface transport security are realized using TLS with server authentication based on the server's certificate issued by CAs in the PKI. For the authentication of the EEC by the EES, the EEC first gets a token from the ECS and sends the token to the EES. It is assumed that there is a business relationship between the ECSPs of the ECS and EES such that the EES can verify the token.

The normative work has been started for Edge Computing Security in 3GPP SA3 working group. For this work, there have been some proposals for authentication of EEC towards EES/ECS Some of the proposals include token-based solutions, which are described in more detail below.

FIG. 6 shows an exemplary signal flow diagram of one proposal for authentication and authorization between EEC and ECS. The following are pre-requisites for the procedure shown in FIG. 6 (shown as operation 0):
EEC is provisioned with a credential to authenticate the ECS.
EEC may be provisioned with a certificate to be authenticated by ECS, or may be provisioned with a token used for EEC authentication and authorization.
ECS may be provisioned with the credential to authenticate the token of the EEC.
If OAuth 2.0 mechanism is selected, ECS should be the OAuth 2.0 Authorization server, and the EEC should be the OAuth2.0 client. ECS and EES share the required credentials.

In operation 1, EEC and ECS establish TLS with the service-side authentication. If the EEC has the certificate, TLS with mutual authentication may be performed. In operation 2, EEC sends the service request to ECS, which may include the token and the GPSI.

In operation 3, ECS should use the static authorization defined in the 3GPP TS 33.501 (v16.4.0) section 13.3.0 to authorize EEC. ECS may authenticate and authorize EEC with the token if included in the service request. If the GPSI is received from the EEC, the ECS should use the IP translation defined in 3GPP SA2 to acquire the GPSI of the UE. Then the ECS verifies the GPSI by comparing the GPSI in the service request and GPSI retrieved from the 3GPP core network. If the authorization and the GPSI verification succeeds, ECS processes the request. ECS may generate an EES service token for the EES service authorization and sends the EES service token to EEC. In operation 4, ECS sends the service response back to EEC.

FIG. 7 shows an exemplary signal flow diagram of a proposal for authentication and authorization between EEC and EES. The following are pre-requisites for the procedure shown in FIG. 7 (shown as operation 0):
EEC is provisioned with a credential to authenticate an EES certificate.
EEC may be provisioned with a certificate to be authenticated by EES, or may be provisioned with a token used for the EEC authentication and authorization.
ECS and EES share the required credentials for OAuth 2.0 mechanism.

In operation 1, EEC and EES establish the TLS with service-side authentication. If EEC has the certificate, TLS with mutual authentication may be performed. In operation 2, EEC sends the service request to EES, which may include the EES service token and the GPSI.

In operation 3, ECS should use the static authorization defined in the 3GPP TS 33.501 (v16.4.0), section 13.3.0 to authorize the EEC. EES may authenticate and authorize EEC with the EES service token if included in the service request. If the GPSI is received from EEC, ECS should use the IP translation defined in 3GPP SA2 to acquire the GPSI of the UE. Then the ECS verifies the GPSI by comparing the GPSI in the service request and GPSI retrieved from the 3GPP core network. If the authorization and the GPSI verification succeeds, EES processes the service request. In operation 4, EES sends the service response back to EEC.

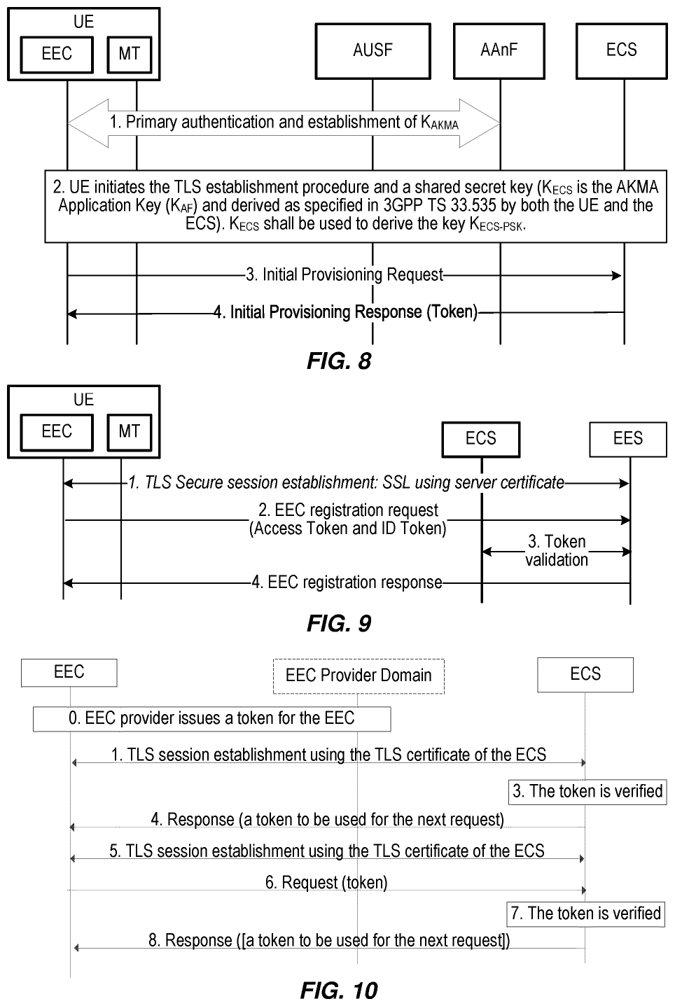

FIG. 8 shows an exemplary signal flow diagram of another proposal for authentication and authorization between EEC and EES. The following are pre-requisites or requirements for the procedure shown in FIG. 8, which includes establishment of TLS with PSK authentication:
ECS shall be able to provide mutual authentication with EEC over EDGE-4 Interface.
ECS shall be able to determine whether EEC is authorized to access ECS's services.
AKMA services shall be used for establishing shared keys between EEC and ECS.
The derived shared key shall be utilized for establishing secure TLS connection.

In operation 1, successful primary authentication results in K_{AUSF} being stored at the AUSF and the UE. UE and AUSF generate AKMA Key material (i.e., K_{AKMA} and A-KID) and AUSF sends this material to AAnF as specified in the 3GPP TS 33.535 (v16.0.0) section 6.1. In operation 2, UE initiates a TLS procedure with ECS for mutual authentication between EEC and ECS, which is an AF for the AAnF as specified in 3GPP TS 33.535 (v16.0.0). A shared secret key K_{ECS} is established between EEC and ECS. The key K_{ECS} is an AKMA Application Key (K_{AF}) and is derived by both UE and ECS as specified in 3GPP TS 33.535 (v16.0.0).

In operations 3-4, after successful derivation of K_{ECS}, a premaster secret key K_{ECS-PSK} is derived for establishing a secure TLS session. EEC initiates the service provisioning procedure with ECS (as specified in 3GPP TS 23.558 (v17.1.0) section 8.3) over the established TLS session. If the UE is authorised to access EES, then ECS generates and provides the access token and ID token to the UE over the established TLS session. Additionally, ECS shall provide the EES root CA certificate to the EEC, which is used to validate the EES's certificate. Access token and ID token are utilized for authentication and authorization between EEC and EES.

FIG. 9 shows an exemplary signal flow diagram of another proposal for authentication and authorization between EEC and ECS. The following are pre-requisites or requirements for the procedure shown in FIG. 9:
EES shall be able to provide mutual authentication with EEC over EDGE-1 Interface.
EES shall be able to determine whether EEC is authorized to access EES's services.
Server (EES) side certificate authentication using TLS and OAuth token-based procedure shall be used for authentication and authorization between EEC and EES.

In operation 1, UE and EES shall establish a secure TLS connection using EES server certificate. ECS may provide EES root CA certificate during the initial provisioning procedure to the EEC to validate the EES's certificate. TLS shall provide integrity protection, replay protection, and confidentiality protection over the EDGE-1 interface.

In operation 2, the UE initiates EEC registration procedure with the EES, including the access token and ID token obtained from the ECS. The access token and ID token shall be included in registration request which provides authentication and the authorization check for the EEC registration request by verifying of the access token and ID token issued by the ECS to the UE. In operation 3, EES obtains token validation from the ECS. In operation 4, EES completes the registration procedure by sending a response to EEC.

FIG. 10 shows an exemplary signal flow diagram of another proposal for authentication and authorization between EEC and ECS. To summarize, TLS certificate of the ECS is used for authentication of the ECS by the EEC. EEC uses a token provided by its EEC provider domain to authenticate itself towards to the ECS. The token may be an access token (OAuth 2.0) for implicit authentication of the EEC or an identity token (OpenID Connect 1.0) for explicit authentication. Since there is a business relationship between the ECSPs of the EEC and ECS, the ECS can verify the token. After the authentication of the EEC, the ECS issues a token for the EEC in the initial access to be used for the next establishment of the communication between them. In the other accesses than the initial access, the ECS decides on whether a new access token is necessary or not, considering information such as the expiration time of the token.

In operation 1, EEC and ECS establish a TLS session using the TLS certificate of the ECS. In operation 2, during the established TLS session, EEC sends the token provided by its provider domain, with ECS verifying the token in operation 3. In operation 4, ECS issues an access or identity token for EEC to use in the next request and sends the token to EEC. In operation 5, EEC and ECS establish a TLS session using the TLS certificate of the ECS. In operation 6, during the established TLS session, EEC sends the token provided by ECS in the previous request, with ECS verifying the token in operation 7. In operation 8, ECS optionally (depending on the expiration time of the token received in operation 6) issues a token for the EEC to use in the next request and sends the token to EEC.

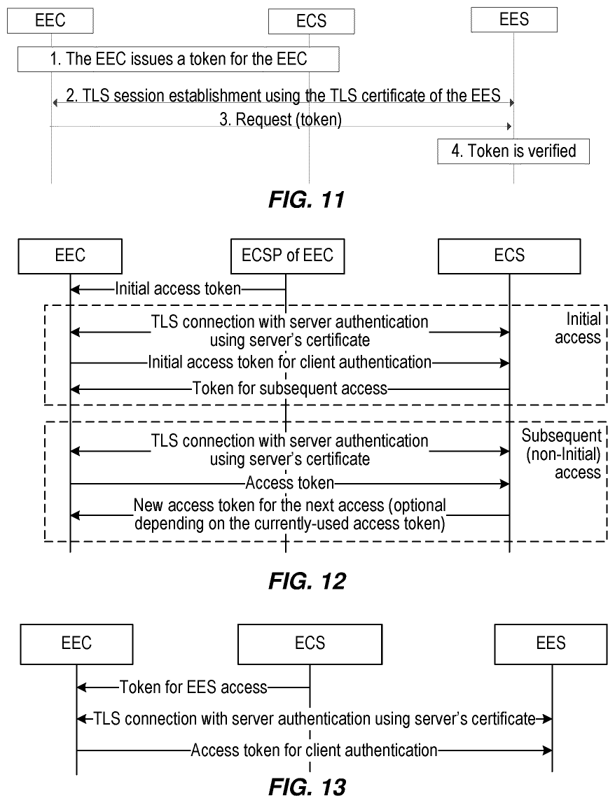

FIG. 11 shows an exemplary signal flow diagram of another proposal for authentication and authorization between EEC and EES. To summarize, TLS certificate of the EES is used for authentication of the EES by the EEC. EEC uses a token provided by ECS to authenticate itself towards to the EES. The token may be an access token (OAuth 2.0) for implicit authentication of the EEC or an identity token (OpenID Connect 1.0) for explicit authentication. Since there is a business relationship between the ECSPs of the EEC and ECS, the EES can verify the token.

In operation 1, ECS issues a token for the EEC to be used for authentication of the EEC by the EES. In operation 2, EEC and EES establish a TLS session using the TLS certificate of the EES. In operation 3, during the established TLS session, EEC sends the token provided by ECS. In operation 4, EES verifies the token.

Other solutions for authentication of EEC towards to EES/ECS involve the service provider of EEC (i.e., ECSP) giving a token to EEC to be used for authentication of EEC by EES/ECS. Some examples are shown in FIGS. 12-14, discussed below.

FIG. 12 shows an exemplary signal flow diagram of one of these solutions for authentication on the EDGE-4 interface between EEC and ECS. In this solution, the authentication of the ECS and the transport security of the interface are realized by using TLS with server authentication using the server's (i.e., ECS) certificate issued by CAs in PKI. Initially, the ECSP provides a token to the EEC. After setup of a TLS connection with server authentication using the ECS certificate, the EEC uses the ECSP-provided access token for EEC authentication with the ECS, which then provides another token for subsequent access by the EEC. One pre-requisite is a business relationship between the ECSP and the ECS, such that the ECS can verify the token provided by ECSP. During the subsequent access, the ECS may decide whether to provide a new access token to the EEC based on, e.g., expiration time of the access token being used. If the ECS does not provide another access token, then the EEC can reuse the same access token.

FIG. 13 shows an exemplary signal flow diagram of one of these solutions for authentication on the EDGE-1 interface between EEC and EES. In this solution, the authentication of the EES and the transport security of the interface are realized by using TLS with server authentication using the server's (i.e., EES) certificate issued by CAs in PKI. As shown in FIG. 13, the ECS initially provides a token to the EEC. After setup of a TLS connection with server authentication using the EES certificate, the EEC uses the ECS-provided access token for EEC authentication with the EES.

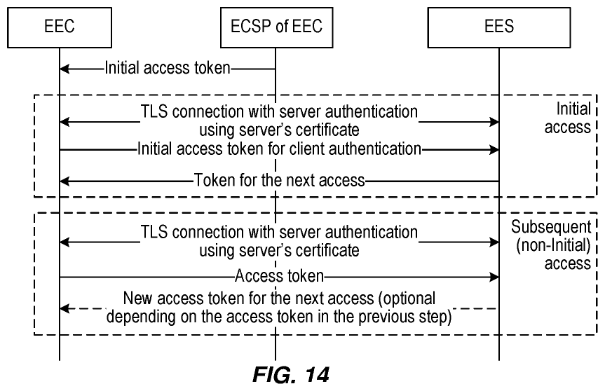

FIG. 14 shows a signal flow diagram of another one of these solutions for authentication on the EDGE-1 interface between EEC and EES. In this solution, the ECSP provides an initial access token to the EEC. After setup of a TLS connection with server authentication using the EES certificate, the EEC uses the ECSP-provided access token for EEC authentication with the EES, which then provides another token for subsequent access by the EEC. One pre-requisite is a business relationship between the ECSP and the EES, such that the EES can verify the token provided by ECSP. During the subsequent access, the EES may decide whether to provide a new access token to the EEC based on, e.g., expiration time of the access token currently being used. If the EES does not provide another access token, then the EEC can reuse the same access token.

In the solutions shown in FIGS. 12-14, the profile for TLS implementation and usage should preferably follow the provisions given in 3GPP TS 33.310 (v16.6.0) Annex E and 3GPP TS 33.210 (v16.4.0) section 6.2. Authentication between applications on the UE (ACs) and servers (EASs) may be dependent on the Operating System of the UE, and thus not in scope of this disclosure. 3GPP TS 23.558 (v17.1.0) clause 7.2.6 specifies different interactions between EEC and EES/ECS that use the UE ID for identifying the UE. The only example for the UE ID is the GPSI, which also requires authentication.

Based on analyzing security requirements for EEC authentication, Applicants have recognized that there may be no need to verify the EEC ID during EEC authentication. For example, application programming interfaces (APIs) provided by EES/ECS and invoked by EEC don't need to validate the EEC ID. These APIs include the following:
Eecs_ServiceProvisioning (provided by ECS). The ECS returns an optimized list of EES to the EEC, considering some parameters such as location of the UE identified by the GPSI sent by the EEC and learned from the 3GPP networks using the IP address of the UE.
Eees_EECRegistration (provided by EES). An EEC performs registration with an EES in order to provide information that can be used by the EES in Edge Computing services.
Eees_EASDiscovery (provided by EES). The ECS returns an optimized list of EAS to the EEC, considering some parameters such as location of the UE identified by the GPSI sent by the EEC and learned from the 3GPP networks using the IP address of the UE.
Eees_AppContextRelocation (provided by EES). Used for ACR initiation or ACR determination
   In view of this, Applicants have recognized that verification of EEC only in terms of whether it is a legitimate application could be sufficient for EEC authentication.

Embodiments of the present disclosure address these and other problems, issues, and/or difficulties by providing techniques whereby ECSP validates the EEC using a proprietary method and issues a credential such as a token, which can be validated by EES and/or ECS. The token comprises one or more of the following: indication that the EEC is a legitimate EEC; EEC type; and EEC ID. The EES and/or ECS can validate the token by using the certificate or public key of the ECSP, used in the credential issue, or by contacting the ECSP. After successful validation of the credential, the EES and/or ECS checks one or more of the following: 1) whether the EEC is a legitimate EEC; EEC type; and EEC ID. After successful check, the EES and/or ECS can issue a new credential to be used in the next communication between EEC and EES/ECS. If the EEC does not have a valid credential because of some reasons such as expiration of the credential, the EEC gets a fresh credential from ECSP.

These embodiments can provide various benefits and/or advantages. For example, such techniques facilitate authentication of EEC based on a credential issued by the ECSP, which can be based on other information than EEC ID. This simplifies EEC authentication and facilitates secure deployment of edge computing within 5G networks.

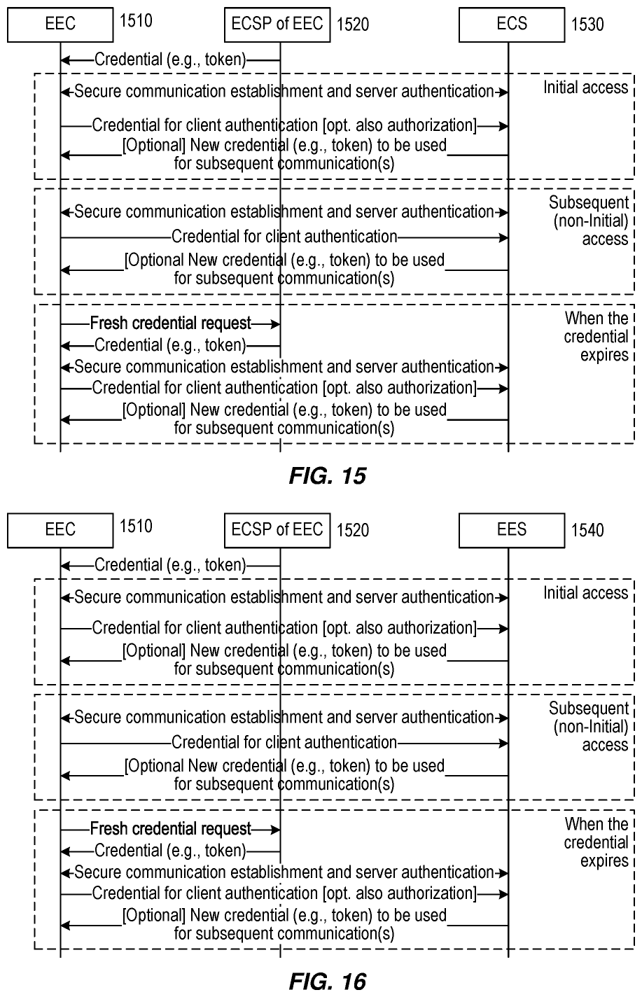

FIG. 15 shows an exemplary signal flow diagram according to some embodiments for authentication on the EDGE-4 interface between EEC (1510) and ECS (1530). In this solution, the authentication of the ECS and the transport security of the interface are realized by using TLS with server authentication using the server's (i.e., ECS 1530) certificate issued by CAs in PKI. Initially, the ECSP (1520) provides a credential (e.g., token) to the EEC. The credential includes an indication that the EEC is a legitimate EEC and/or an EEC type (i.e., a type associated with the EEC). Optionally, the credential can include the EEC ID.

After setup of a TLS connection with server authentication using the ECS certificate, the EEC uses the ECSP-provided credential for EEC authentication with the ECS. Optionally, the ECS can also authorize the EEC (e.g., for ECS access) based on information (e.g., indication of legitimacy and/or EEC type) in the ECSP-provided credential. One pre-requisite is a business relationship between the ECSP and the ECS, such that the ECS can verify the credential provided by ECSP. Optionally, the ECS then provides a new credential (e.g., token) for subsequent access by the EEC. During the subsequent access, the ECS may decide whether to provide a new credential (e.g., token) to the EEC based on, e.g., expiration time of the access token being used. If the ECS does not provide another credential, then the EEC can reuse the same credential for next access.

Upon expiration of the latest credential received by the EEC, the EEC sends a request to ECSP for a fresh or updated credential, and receives a new valid credential in response. The EEC can then proceed with the same operations as in previous accesses to ECS, but using the new credential instead.

FIG. 16 shows a signal flow diagram of another one of these solutions for authentication on the EDGE-1 interface between EEC (1510) and EES (1540). In this solution, the authentication of the EES and the transport security of the interface are realized by using TLS with server authentication using the server's (i.e., EES 1540) certificate issued by CAs in PKI. Initially, the ECSP (1520) provides a credential (e.g., token) to the EEC. The credential includes an indication that the EEC is a legitimate EEC and/or an EEC type (i.e., a type associated with the EEC). Optionally, the credential can include the EEC ID.

After setup of a TLS connection with server authentication using the EES certificate, the EEC uses the ECSP-provided credential for EEC authentication with the EES. Optionally, the EES can also authorize the EEC (e.g., for EES access) based on information (e.g., indication of legitimacy and/or EEC type) in the ECSP-provided credential. One pre-requisite is a business relationship between the ECSP and the EES, such that the EES can verify the credential provided by ECSP. Optionally, the EES then provides anew credential (e.g., token) for subsequent access by the EEC. During the subsequent access, the EES may decide whether to provide a new credential (e.g., token) to the EEC based on, e.g., expiration time of the access token being used. If the EES does not provide another credential, then the EEC can reuse the same credential for next access.

Upon expiration of the latest credential received by the EEC, the EEC sends a request to ECSP for a fresh or updated credential, and receives a new valid credential in response. The EEC can then proceed with the same operations as in previous accesses to EES, but using the new credential instead.

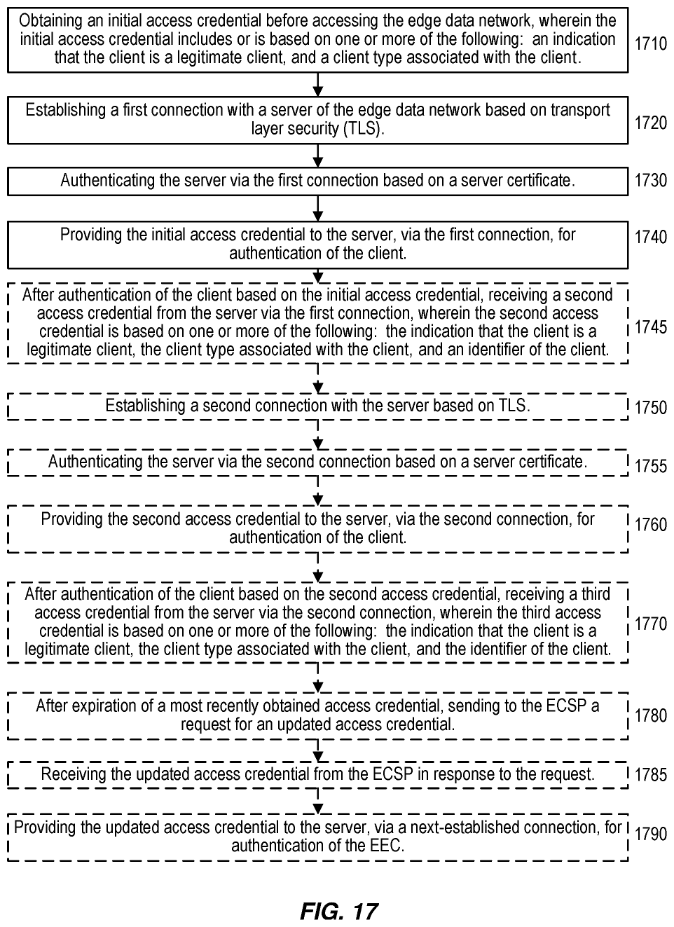

The embodiments described above can be further illustrated with reference to FIGS. 17-19, which depict exemplary methods (e.g., procedures) performed by a client in an edge data network, a server in the edge data network, and a credential provider associated with the edge data network, respectively. Put differently, various features of the operations described below correspond to various embodiments described above. The exemplary methods shown in FIGS. 17-19 can be complementary to each other such that they can be used cooperatively to provide benefits, advantages, and/or solutions to problems described herein. Although the exemplary methods are illustrated in FIGS. 17-19 by specific blocks in particular orders, the operations corresponding to the blocks can be performed in different orders than shown and can be combined and/or divided into operations having different functionality than shown. Optional blocks and/or operations are indicated by dashed lines.

More specifically, FIG. 17 illustrates an exemplary method (e.g., procedure) for a client in an edge data network (e.g., 5G network), according to various embodiments of the present disclosure. The exemplary method shown in FIG. 8 can be performed by an edge client of a user equipment (UE, e.g., wireless device), such as an EEC described herein with reference to other figures.

The exemplary method can include the operations of block 1710, where the client can obtain an initial access credential before accessing the edge data network. The initial access credential includes or is based on one or more of the following: an indication that the client is a legitimate client, and a client type associated with the client. In some embodiments, the initial access credential also includes or is further based on an identifier of the client.

The exemplary method can also include the operations of block 1720, where the client can establish a first connection with a server of the edge data network based on transport layer security (TLS). The exemplary method can also include the operations of block 1730, where the client can authenticate the server via the first connection based on a server certificate. The exemplary method can also include the operations of block 1740, where the client can provide the initial access credential to the server, via the first connection, for authentication of the client.

In some embodiments, the exemplary method can also include the operations of block 1745, where the client can, after authentication of the client based on the initial access credential, receive a second access credential from the server via the first connection. The second access credential includes or is based on one or more of the following: the indication that the client is a legitimate client, the client type associated with the client, and an identifier of the client.

In some of these embodiments, the exemplary method can also include the operations of blocks 1750-1760. In block 1750, the client can establish a second connection with the server based on TLS. This can be done, for example, sometime after the first connection has been disconnected, removed, deactivated, etc. In block 1755, the client can authenticate the server via the second connection based on a server certificate. In block 1760, the client can provide the second access credential to the server, via the second connection, for authentication of the client.

In some variants, the exemplary method can also include the operations of block 1770, where the client can, after authentication of the client based on the second access credential, receive a third access credential from the server via the second connection. The third access credential includes or is based on one or more of the following: the indication that the client is a legitimate client, the client type associated with the client, and the identifier of the client.

In some embodiments, the client is an Edge Enabler Client (EEC) and the initial access credential is obtained from an edge computing service provider (ECSP) that is associated with the EEC. In some of these embodiments, the exemplary method can also include the operations of blocks 1780-1790. In blocks 1780-1785, after expiration of a most recently obtained access credential (e.g., initial, second, or third), the client can send to the ECSP a request for an updated access credential and receive the updated access credential from the ECSP in response to the request. In block 1790, the client can provide the updated access credential to the server, via a next-established connection (i.e., next connection established with the server), for authentication of the EEC. In some variants, the updated access credential includes or is based on one or more of the following: the indication that the client is a legitimate client, and the client type associated with the client. In this manner, the updated access credential can be similar to the initial access credential that was provided by the ECSP.

In various embodiments, the server is an ECS or an EES, as illustrated in FIGS. 15-16 respectively. In various embodiments, each of the various access credentials mentioned above can be a token, certificate, or any other relevant type of credential that facilitates the operations described above.

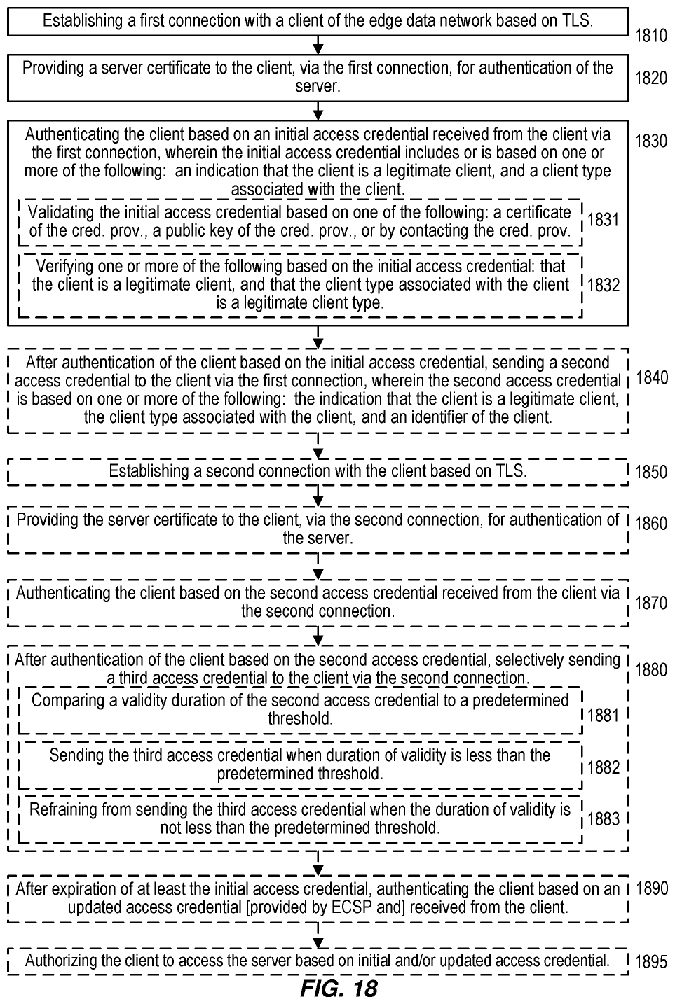

In addition, FIG. 18 illustrates an exemplary method (e.g., procedure) for a server in an edge data network (e.g., 5G network), according to various embodiments of the present disclosure. The exemplary method shown in FIG. 18 can be performed by any appropriate server (e.g., EES, ECS, etc.) such as shown and/or described in relation to other figures herein.

The exemplary method can include the operations of block 1810, where the server can establish a first connection with a client of the edge data network based on TLS. The exemplary method can also include the operations of block 1820, where the server can provide a server certificate to the client, via the first connection, for authentication of the server. The exemplary method can also include the operation of block 1830, where the server can authenticate the client based on an initial access credential received from the client via the first connection. The initial access credential includes or is based on one or more of the following: an indication that the client is a legitimate client, and a client type associated with the client. In some embodiments, the initial access credential also includes or is further based on an identifier of the client.

In some embodiments, the exemplary method can also include the operations of block 1840, where the server can, after authentication of the client based on the initial access credential, send a second access credential to the client via the first connection. The second access credential includes or is based on one or more of the following: the indication that the client is a legitimate client, the client type associated with the client, and the identifier of the client.

In some of these embodiments, the exemplary method can also include the operations of blocks 1850-1870. In block 1850, the server can establish a second connection with the client based on TLS. This can be done, for example, sometime after the first connection has been disconnected, removed, deactivated, etc. In block 1860, the server can provide the server certificate to the client, via the second connection, for authentication of the server. In block 1870, the server can authenticate the client based on the second access credential received from the client via the second connection.

In some of these embodiments, the exemplary method can also include the operations of block 1880, where the server can, after authentication of the client based on the second access credential, selectively send a third access credential to the client via the second connection. The third access credential includes or is based on one or more of the following: the indication that the client is a legitimate client, the client type associated with the client, and the identifier of the client.

In some embodiments, the selectively sending operations of block 1880 can include the operations of sub-blocks 1881-1883, where the server can compare a duration of validity of the second access credential to a predetermined threshold; send the third access credential when the duration of validity is less than the predetermined threshold; and refrain from sending the third access credential when the duration of validity is not less than the predetermined threshold.

In some embodiments, the initial access credential is obtained by the client from a credential provider other than the server and the authenticating operations in block 1830 can include the operations of sub-blocks 1831-1832. In sub-block 1831, the server can validate the initial access credential based on one of the following: a certificate of the credential provider, a public key of the credential provider, or by contacting the credential provider. In sub-block 1832, the server can verify one or more of the following based on the initial access credential: that the client is a legitimate client, and that the client type associated with the client is a legitimate client type.

In some embodiments, the exemplary method can also include the operations of block 1890, where after expiration of at least the initial access credential, the server can authenticate the client based on an updated access credential received from the client. Like the initial access credential, the updated access credential includes or is based on one or more of the following: an indication that the client is a legitimate client, and a client type associated with the client.

In some of these embodiments, the exemplary method can also include the operations of block 1895, where the server can authorize the client to access the server based on at least one of the following: the initial access credential, and the updated access credential. In some of these embodiments, the client is an Edge Enabler Client (EEC) and the initial access credential and the updated access credential are obtained by the EEC from an edge computing service provider (ECSP) associated with the EEC.

In various embodiments, the server is an ECS or an EES, as illustrated in FIGS. 15-16 respectively. In various embodiments, each of the various access credentials mentioned above can be a token, certificate, or any other relevant type of credential that facilitates the operations described above.

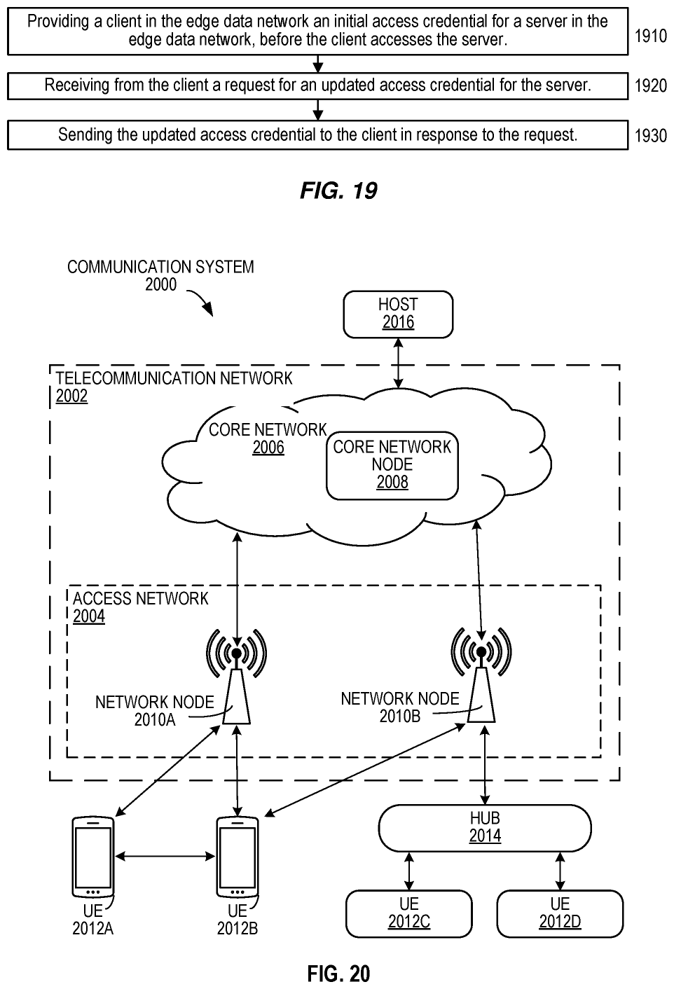

In addition, FIG. 19 illustrates an exemplary method (e.g., procedure) for a credential provider associated with an edge data network (e.g., 5G network), according to various embodiments of the present disclosure. The exemplary method shown in FIG. 19 can be performed by any appropriate credential provider (e.g., ECSP, etc.) such as shown and/or described in relation to other figures herein.

The exemplary method can include the operations of block 1910, where the credential provider can provide a client in the edge data network an initial access credential for a server in the edge data network, before the client accesses the server. The exemplary method can also include the operations of block 1920, where the credential provider can receive from the client a request for an updated access credential for the server. The exemplary method can also include the operation of block 1930, where the credential provider can send the updated access credential to the client in response to the request. The initial access credential and the updated access credential include or are based on one or more of the following: an indication that the client is a legitimate client, and a client type associated with the client. In some embodiments, at least one of the initial access credential and the updated access credential also includes or is further based on an identifier of the client.

In some embodiments, the client is an EEC and the credential provider is an ECSP that is associated with the EEC. In various embodiments, each of the various access credentials mentioned above can be a token, certificate, or any other relevant type of credential that facilitates the operations described above.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

FIG. 20 shows an example of a communication system 2000 in accordance with some embodiments. In this example, communication system 2000 includes a telecommunication network 2002 that includes an access network 2004, such as a radio access network (RAN), and a core network 2006, which includes one or more core network nodes 2008. The access network 2004 includes one or more access network nodes, such as network nodes 2010a and 2010b (one or more of which may be generally referred to as network nodes 2010), or any other similar 3^{rd} Generation Partnership Project (3GPP) access node or non-3GPP access point. The network nodes 2010 facilitate direct or indirect connection of user equipment (UE), such as by connecting UEs 2012a, 2012b, 2012c, and 2012d (one or more of which may be generally referred to as UEs 2012) to the core network 2006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2000 may include any number of wired or wireless networks, network nodes, UEs, and/or any other components or systems that may facilitate or participate in the communication of data and/or signals whether via wired or wireless connections. The communication system 2000 may include and/or interface with any type of communication, telecommunication, data, cellular, radio network, and/or other similar type of system.

The UEs 2012 may be any of a wide variety of communication devices, including wireless devices arranged, configured, and/or operable to communicate wirelessly with the network nodes 2010 and other communication devices. Similarly, the network nodes 2010 are arranged, capable, configured, and/or operable to communicate directly or indirectly with the UEs 2012 and/or with other network nodes or equipment in the telecommunication network 2002 to enable and/or provide network access, such as wireless network access, and/or to perform other functions, such as administration in the telecommunication network 2002.

In the depicted example, the core network 2006 connects the network nodes 2010 to one or more hosts, such as host 2016. These connections may be direct or indirect via one or more intermediary networks or devices. In other examples, network nodes may be directly coupled to hosts. The core network 2006 includes one more core network nodes (e.g., core network node 2008) that are structured with hardware and software components. Features of these components may be substantially similar to those described with respect to the UEs, network nodes, and/or hosts, such that the descriptions thereof are generally applicable to the corresponding components of the core network node 2008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2016 may be under the ownership or control of a service provider other than an operator or provider of the access network 2004 and/or the telecommunication network 2002, and may be operated by the service provider or on behalf of the service provider. The host 2016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2000 of FIG. 20 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2002 is a cellular network that implements 3GPP standardized features. Accordingly, the telecommunications network 2002 may support network slicing to provide different logical networks to different devices that are connected to the telecommunication network 2002. For example, the telecommunications network 2002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2012 are configured to transmit and/or receive information without direct human interaction. For instance, a UE may be designed to transmit information to the access network 2004 on a predetermined schedule, when triggered by an internal or external event, or in response to requests from the access network 2004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2014 communicates with the access network 2004 to facilitate indirect communication between one or more UEs (e.g., UE 2012c and/or 2012d) and network nodes (e.g., network node 2010b). In some examples, the hub 2014 may be a controller, router, content source and analytics, or any of the other communication devices described herein regarding UEs. For example, the hub 2014 may be a broadband router enabling access to the core network 2006 for the UEs. As another example, the hub 2014 may be a controller that sends commands or instructions to one or more actuators in the UEs. Commands or instructions may be received from the UEs, network nodes 2010, or by executable code, script, process, or other instructions in the hub 2014. As another example, the hub 2014 may be a data collector that acts as temporary storage for UE data and, in some embodiments, may perform analysis or other processing of the data. As another example, the hub 2014 may be a content source. For example, for a UE that is a VR headset, display, loudspeaker or other media delivery device, the hub 2014 may retrieve VR assets, video, audio, or other media or data related to sensory information via a network node, which the hub 2014 then provides to the UE either directly, after performing local processing, and/or after adding additional local content. In still another example, the hub 2014 acts as a proxy server or orchestrator for the UEs, in particular in if one or more of the UEs are low energy IoT devices.

The hub 2014 may have a constant/persistent or intermittent connection to the network node 2010b. The hub 2014 may also allow for a different communication scheme and/or schedule between the hub 2014 and UEs (e.g., UE 2012c and/or 2012d), and between the hub 2014 and the core network 2006. In other examples, the hub 2014 is connected to the core network 2006 and/or one or more UEs via a wired connection. Moreover, the hub 2014 may be configured to connect to an M2M service provider over the access network 2004 and/or to another UE over a direct connection. In some scenarios, UEs may establish a wireless connection with the network nodes 2010 while still connected via the hub 2014 via a wired or wireless connection. In some embodiments, the hub 2014 may be a dedicated hub—that is, a hub whose primary function is to route communications to/from the UEs from/to the network node 2010b. In other embodiments, the hub 2014 may be a non-dedicated hub—that is, a device which is capable of operating to route communications between the UEs and network node 2010b, but which is additionally capable of operating as a communication start and/or end point for certain data channels.

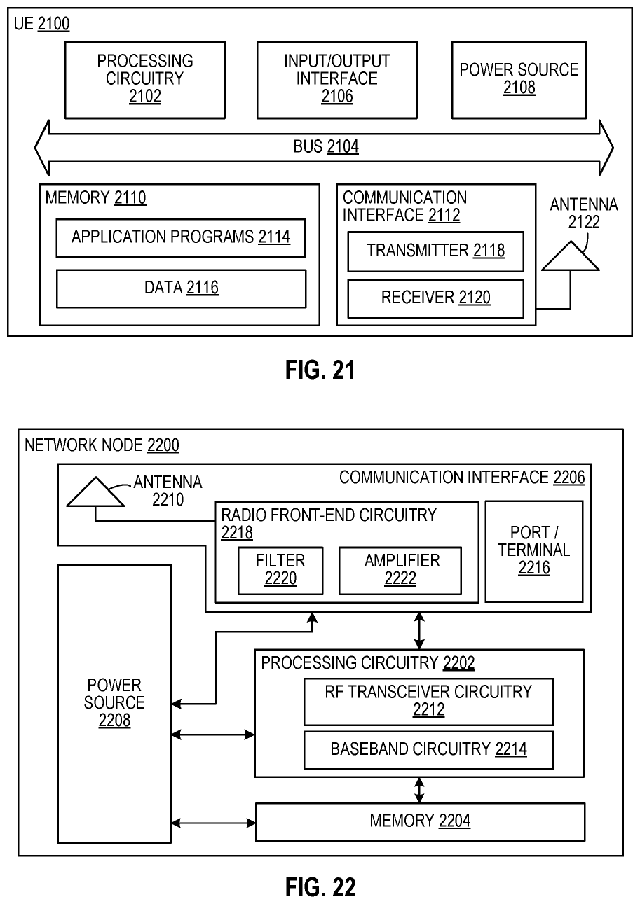

FIG. 21 shows a UE 2100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2100 includes processing circuitry 2102 that is operatively coupled via a bus 2104 to an input/output interface 2106, a power source 2108, a memory 2110, a communication interface 2112, and/or any other component, or any combination thereof. Certain UEs may utilize all or a subset of the components shown in FIG. 21. The level of integration between the components may vary from one UE to another UE. Further, certain UEs may contain multiple instances of a component, such as multiple processors, memories, transceivers, transmitters, receivers, etc.

The processing circuitry 2102 is configured to process instructions and data and may be configured to implement any sequential state machine operative to execute instructions stored as machine-readable computer programs in the memory 2110. The processing circuitry 2102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2102 may include multiple central processing units (CPUs).

In the example, the input/output interface 2106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2108 is structured as a battery or battery pack. Other types of power sources, such as an external power source (e.g., an electricity outlet), photovoltaic device, or power cell, may be used. The power source 2108 may further include power circuitry for delivering power from the power source 2108 itself, and/or an external power source, to the various parts of the UE 2100 via input circuitry or an interface such as an electrical power cable. Delivering power may be, for example, for charging of the power source 2108. Power circuitry may perform any formatting, converting, or other modification to the power from the power source 2108 to make the power suitable for the respective components of the UE 2100 to which power is supplied.

The memory 2110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2110 includes one or more application programs 2114, such as an operating system, web browser application, a widget, gadget engine, or other application, and corresponding data 2116. The memory 2110 may store, for use by the UE 2100, any of a variety of various operating systems or combinations of operating systems.

The memory 2110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2110 may allow the UE 2100 to access instructions, application programs and the like, stored on transitory or non-transitory memory media, to off-load data, or to upload data. An article of manufacture, such as one utilizing a communication system may be tangibly embodied as or in the memory 2110, which may be or comprise a device-readable storage medium.

The processing circuitry 2102 may be configured to communicate with an access network or other network using the communication interface 2112. The communication interface 2112 may comprise one or more communication subsystems and may include or be communicatively coupled to an antenna 2122. The communication interface 2112 may include one or more transceivers used to communicate, such as by communicating with one or more remote transceivers of another device capable of wireless communication (e.g., another UE or a network node in an access network). Each transceiver may include a transmitter 2118 and/or a receiver 2120 appropriate to provide network communications (e.g., optical, electrical, frequency allocations, and so forth). Moreover, the transmitter 2118 and receiver 2120 may be coupled to one or more antennas (e.g., antenna 2122) and may share circuit components, software or firmware, or alternatively be implemented separately.

In the illustrated embodiment, communication functions of the communication interface 2112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2100 shown in FIG. 21.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 22 shows a network node 2200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2200 includes a processing circuitry 2202, a memory 2204, a communication interface 2206, and a power source 2208. The network node 2200 may be composed of multiple physically separate components (e.g., a NodeB component and a RNC component, or a BTS component and a BSC component, etc.), which may each have their own respective components. In certain scenarios in which the network node 2200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2200 may be configured to support multiple radio access technologies (RATs). In such embodiments, some components may be duplicated (e.g., separate memory 2204 for different RATs) and some components may be reused (e.g., a same antenna 2210 may be shared by different RATs). The network node 2200 may also include multiple sets of the various illustrated components for different wireless technologies integrated into network node 2200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2200.

The processing circuitry 2202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2200 components, such as the memory 2204, to provide network node 2200 functionality.

In some embodiments, the processing circuitry 2202 includes a system on a chip (SOC). In some embodiments, the processing circuitry 2202 includes one or more of radio frequency (RF) transceiver circuitry 2212 and baseband processing circuitry 2214. In some embodiments, the radio frequency (RF) transceiver circuitry 2212 and the baseband processing circuitry 2214 may be on separate chips (or sets of chips), boards, or units, such as radio units and digital units. In alternative embodiments, part or all of RF transceiver circuitry 2212 and baseband processing circuitry 2214 may be on the same chip or set of chips, boards, or units.

The memory 2204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2202. The memory 2204 may store any suitable instructions, data, or information, including a computer program, software, an application including one or more of logic, rules, code, tables, and/or other instructions capable of being executed by the processing circuitry 2202 and utilized by the network node 2200. The memory 2204 may be used to store any calculations made by the processing circuitry 2202 and/or any data received via the communication interface 2206. In some embodiments, the processing circuitry 2202 and memory 2204 is integrated.

The communication interface 2206 is used in wired or wireless communication of signaling and/or data between a network node, access network, and/or UE. As illustrated, the communication interface 2206 comprises port(s)/terminal(s) 2216 to send and receive data, for example to and from a network over a wired connection. The communication interface 2206 also includes radio front-end circuitry 2218 that may be coupled to, or in certain embodiments a part of, the antenna 2210. Radio front-end circuitry 2218 comprises filters 2220 and amplifiers 2222. The radio front-end circuitry 2218 may be connected to an antenna 2210 and processing circuitry 2202. The radio front-end circuitry may be configured to condition signals communicated between antenna 2210 and processing circuitry 2202. The radio front-end circuitry 2218 may receive digital data that is to be sent out to other network nodes or UEs via a wireless connection. The radio front-end circuitry 2218 may convert the digital data into a radio signal having the appropriate channel and bandwidth parameters using a combination of filters 2220 and/or amplifiers 2222. The radio signal may then be transmitted via the antenna 2210. Similarly, when receiving data, the antenna 2210 may collect radio signals which are then converted into digital data by the radio front-end circuitry 2218. The digital data may be passed to the processing circuitry 2202. In other embodiments, the communication interface may comprise different components and/or different combinations of components.

In certain alternative embodiments, the network node 2200 does not include separate radio front-end circuitry 2218, instead, the processing circuitry 2202 includes radio front-end circuitry and is connected to the antenna 2210. Similarly, in some embodiments, all or some of the RF transceiver circuitry 2212 is part of the communication interface 2206. In still other embodiments, the communication interface 2206 includes one or more ports or terminals 2216, the radio front-end circuitry 2218, and the RF transceiver circuitry 2212, as part of a radio unit (not shown), and the communication interface 2206 communicates with the baseband processing circuitry 2214, which is part of a digital unit (not shown).

The antenna 2210 may include one or more antennas, or antenna arrays, configured to send and/or receive wireless signals. The antenna 2210 may be coupled to the radio front-end circuitry 2218 and may be any type of antenna capable of transmitting and receiving data and/or signals wirelessly. In certain embodiments, the antenna 2210 is separate from the network node 2200 and connectable to the network node 2200 through an interface or port.

The antenna 2210, communication interface 2206, and/or the processing circuitry 2202 may be configured to perform any receiving operations and/or certain obtaining operations described herein as being performed by the network node. Any information, data and/or signals may be received from a UE, another network node and/or any other network equipment. Similarly, the antenna 2210, the communication interface 2206, and/or the processing circuitry 2202 may be configured to perform any transmitting operations described herein as being performed by the network node. Any information, data and/or signals may be transmitted to a UE, another network node and/or any other network equipment.

The power source 2208 provides power to the various components of network node 2200 in a form suitable for the respective components (e.g., at a voltage and current level needed for each respective component). The power source 2208 may further comprise, or be coupled to, power management circuitry to supply the components of the network node 2200 with power for performing the functionality described herein. For example, the network node 2200 may be connectable to an external power source (e.g., the power grid, an electricity outlet) via an input circuitry or interface such as an electrical cable, whereby the external power source supplies power to power circuitry of the power source 2208. As a further example, the power source 2208 may comprise a source of power in the form of a battery or battery pack which is connected to, or integrated in, power circuitry. The battery may provide backup power should the external power source fail.

Embodiments of the network node 2200 may include additional components beyond those shown in FIG. 22 for providing certain aspects of the network node's functionality, including any of the functionality described herein and/or any functionality necessary to support the subject matter described herein. For example, the network node 2200 may include user interface equipment to allow input of information into the network node 2200 and to allow output of information from the network node 2200. This may allow a user to perform diagnostic, maintenance, repair, and other administrative functions for the network node 2200.

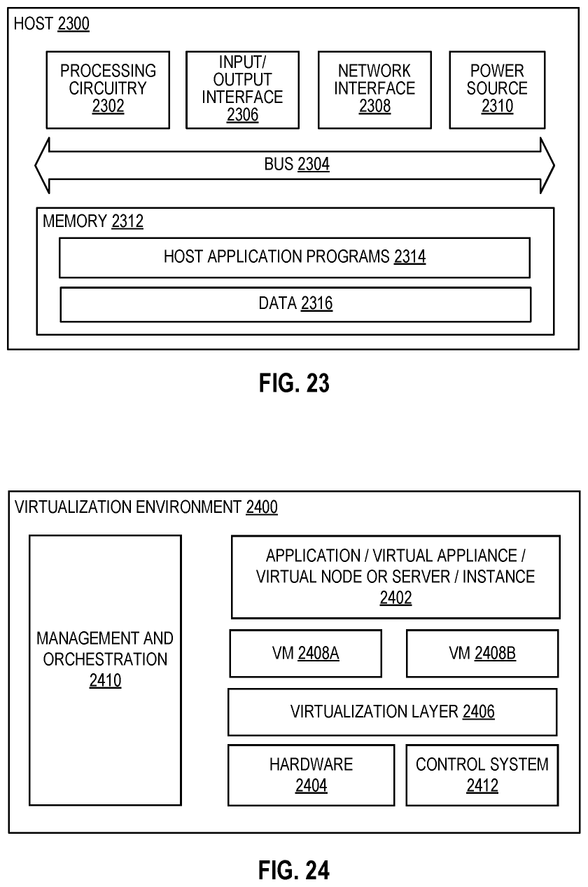

FIG. 23 is a block diagram of a host 2300, which may be an embodiment of the host 2016 of FIG. 20, in accordance with various aspects described herein. As used herein, the host 2300 may be or comprise various combinations hardware and/or software, including a standalone server, a blade server, a cloud-implemented server, a distributed server, a virtual machine, container, or processing resources in a server farm. The host 2300 may provide one or more services to one or more UEs.

The host 2300 includes processing circuitry 2302 that is operatively coupled via a bus 2304 to an input/output interface 2306, a network interface 2308, a power source 2310, and a memory 2312. Other components may be included in other embodiments. Features of these components may be substantially similar to those described with respect to the devices of previous figures, such as FIGS. 21 and 22, such that the descriptions thereof are generally applicable to the corresponding components of host 2300.

The memory 2312 may include one or more computer programs including one or more host application programs 2314 and data 2316, which may include user data, e.g., data generated by a UE for the host 2300 or data generated by the host 2300 for a UE. Embodiments of the host 2300 may utilize only a subset or all of the components shown. The host application programs 2314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2314 may also provide for user authentication and licensing checks and may periodically report health, routes, and content availability to a central node, such as a device in or on the edge of a core network. Accordingly, the host 2300 may select and/or indicate a different host for over-the-top services for a UE. The host application programs 2314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 24 is a block diagram illustrating a virtualization environment 2400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2406 (also referred to as hypervisors or virtual machine monitors (VMMs)), provide VMs 2408a and 2408b (one or more of which may be generally referred to as VMs 2408), and/or perform any of the functions, features and/or benefits described in relation with some embodiments described herein. The virtualization layer 2406 may present a virtual operating platform that appears like networking hardware to the VMs 2408.

The VMs 2408 comprise virtual processing, virtual memory, virtual networking or interface and virtual storage, and may be run by a corresponding virtualization layer 2406. Different embodiments of the instance of a virtual appliance 2402 may be implemented on one or more of VMs 2408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2408 may be a software implementation of a physical machine that runs programs as if they were executing on a physical, non-virtualized machine. Each of the VMs 2408, and that part of hardware 2404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2408 on top of the hardware 2404 and corresponds to the application 2402.

Hardware 2404 may be implemented in a standalone network node with generic or specific components. Hardware 2404 may implement some functions via virtualization. Alternatively, hardware 2404 may be part of a larger cluster of hardware (e.g. such as in a data center or CPE) where many hardware nodes work together and are managed via management and orchestration 2410, which, among others, oversees lifecycle management of applications 2402. In some embodiments, hardware 2404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2412 which may alternatively be used for communication between hardware nodes and radio units.

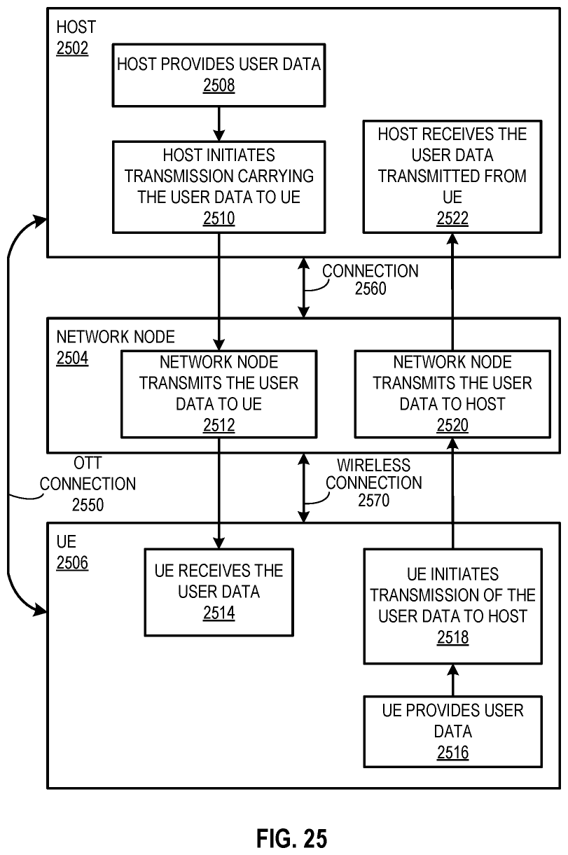

FIG. 25 shows a communication diagram of a host 2502 communicating via a network node 2504 with a UE 2506 over a partially wireless connection in accordance with some embodiments. Example implementations, in accordance with various embodiments, of the UE (such as a UE 2012a of FIG. 20 and/or UE 2100 of FIG. 21), network node (such as network node 2010a of FIG. 20 and/or network node 2200 of FIG. 22), and host (such as host 2016 of FIG. 20 and/or host 2300 of FIG. 23) discussed in the preceding paragraphs will now be described with reference to FIG. 25.

Like host 2300, embodiments of host 2502 include hardware, such as a communication interface, processing circuitry, and memory. The host 2502 also includes software, which is stored in or accessible by the host 2502 and executable by the processing circuitry. The software includes a host application that may be operable to provide a service to a remote user, such as the UE 2506 connecting via an over-the-top (OTT) connection 2550 extending between the UE 2506 and host 2502. In providing the service to the remote user, a host application may provide user data which is transmitted using the OTT connection 2550.

The network node 2504 includes hardware enabling it to communicate with the host 2502 and UE 2506. The connection 2560 may be direct or pass through a core network (like core network 2006 of FIG. 20) and/or one or more other intermediate networks, such as one or more public, private, or hosted networks. For example, an intermediate network may be a backbone network or the Internet.

The UE 2506 includes hardware and software, which is stored in or accessible by UE 2506 and executable by the UE's processing circuitry. The software includes a client application, such as a web browser or operator-specific “app” that may be operable to provide a service to a human or non-human user via UE 2506 with the support of the host 2502. In the host 2502, an executing host application may communicate with the executing client application via the OTT connection 2550 terminating at the UE 2506 and host 2502. In providing the service to the user, the UE's client application may receive request data from the host's host application and provide user data in response to the request data. The OTT connection 2550 may transfer both the request data and the user data. The UE's client application may interact with the user to generate the user data that it provides to the host application through the OTT connection 2550.

The OTT connection 2550 may extend via a connection 2560 between the host 2502 and the network node 2504 and via a wireless connection 2570 between the network node 2504 and the UE 2506 to provide the connection between the host 2502 and the UE 2506. The connection 2560 and wireless connection 2570, over which the OTT connection 2550 may be provided, have been drawn abstractly to illustrate the communication between the host 2502 and the UE 2506 via the network node 2504, without explicit reference to any intermediary devices and the precise routing of messages via these devices.

As an example of transmitting data via the OTT connection 2550, in step 2508, the host 2502 provides user data, which may be performed by executing a host application. In some embodiments, the user data is associated with a particular human user interacting with the UE 2506. In other embodiments, the user data is associated with a UE 2506 that shares data with the host 2502 without explicit human interaction. In step 2510, the host 2502 initiates a transmission carrying the user data towards the UE 2506. The host 2502 may initiate the transmission responsive to a request transmitted by the UE 2506. The request may be caused by human interaction with the UE 2506 or by operation of the client application executing on the UE 2506. The transmission may pass via the network node 2504, in accordance with the teachings of the embodiments described throughout this disclosure. Accordingly, in step 2512, the network node 2504 transmits to the UE 2506 the user data that was carried in the transmission that the host 2502 initiated, in accordance with the teachings of the embodiments described throughout this disclosure. In step 2514, the UE 2506 receives the user data carried in the transmission, which may be performed by a client application executed on the UE 2506 associated with the host application executed by the host 2502.

In some examples, the UE 2506 executes a client application which provides user data to the host 2502. The user data may be provided in reaction or response to the data received from the host 2502. Accordingly, in step 2516, the UE 2506 may provide user data, which may be performed by executing the client application. In providing the user data, the client application may further consider user input received from the user via an input/output interface of the UE 2506. Regardless of the specific manner in which the user data was provided, the UE 2506 initiates, in step 2518, transmission of the user data towards the host 2502 via the network node 2504. In step 2520, in accordance with the teachings of the embodiments described throughout this disclosure, the network node 2504 receives user data from the UE 2506 and initiates transmission of the received user data towards the host 2502. In step 2522, the host 2502 receives the user data carried in the transmission initiated by the UE 2506.

One or more of the various embodiments improve the performance of OTT services provided to the UE 2506 using the OTT connection 2550, in which the wireless connection 2570 forms the last segment. More precisely, embodiments described herein can facilitate authentication of edge enabler clients (EEC) based on a credential issued by an edge computing service provider (ECSP) associated with the EEC. This credential can be based on information than EEC identifier, which can simplify EEC authentication and facilitate secure deployment of edge computing within 5G networks. When edge computing deployed in this manner is used to provide and/or support OTT data services, it increases the value of such services to both end users and service providers.

In an example scenario, factory status information may be collected and analyzed by the host 2502. As another example, the host 2502 may process audio and video data which may have been retrieved from a UE for use in creating maps. As another example, the host 2502 may collect and analyze real-time data to assist in controlling vehicle congestion (e.g., controlling traffic lights). As another example, the host 2502 may store surveillance video uploaded by a UE. As another example, the host 2502 may store or control access to media content such as video, audio, VR or AR which it can broadcast, multicast or unicast to UEs. As other examples, the host 2502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2550 between the host 2502 and UE 2506, in response to variations in the measurement results. The measurement procedure and/or the network functionality for reconfiguring the OTT connection may be implemented in software and hardware of the host 2502 and/or UE 2506. In some embodiments, sensors (not shown) may be deployed in or in association with other devices through which the OTT connection 2550 passes; the sensors may participate in the measurement procedure by supplying values of the monitored quantities exemplified above, or supplying values of other physical quantities from which software may compute or estimate the monitored quantities. The reconfiguring of the OTT connection 2550 may include message format, retransmission settings, preferred routing etc.; the reconfiguring need not directly alter the operation of the network node 2504. Such procedures and functionalities may be known and practiced in the art. In certain embodiments, measurements may involve proprietary UE signaling that facilitates measurements of throughput, propagation times, latency and the like, by the host 2502. The measurements may be implemented in that software causes messages to be transmitted, in particular empty or ‘dummy’ messages, using the OTT connection 2550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1.-32. (canceled)

33. A method for a client in an edge data network, the method comprising:
obtaining an initial access credential before accessing the edge data network, wherein the initial access credential includes or is based on one or more of an indication that the client is a legitimate client, a client type associated with the client and an identifier of the client;
establishing a first connection with a server of the edge data network based on transport layer security (TLS);
authenticating the server via the first connection based on a server certificate; and
providing the initial access credential to the server, via the first connection, for authentication of the client.

34. The method of claim 33, wherein:
the method further comprises, after authentication of the client based on the initial access credential, receiving a second access credential from the server via the first connection; and
the second access credential includes or is based on one or more of the following: the indication that the client is a legitimate client; the client type associated with the client; and an identifier of the client.

35. The method of claim 34, further comprising:
subsequently establishing a second connection with the server based on TLS;
authenticating the server via the second connection based on a server certificate; and
providing the second access credential to the server, via the second connection, for authentication of the client.

36. The method of claim 35, wherein:
the method further comprises, after authentication of the client based on the second access credential, receiving a third access credential from the server via the second connection; and
the third access credential includes or is based on one or more of the following: the indication that the client is a legitimate client; the client type associated with the client; and the identifier of the client.

37. The method of claim 33, wherein the client is an Edge Enabler Client (EEC) and the method further comprises:
obtaining the initial access credential from an edge computing service provider (ECSP) that is associated with the EEC;
after expiration of a most recently obtained access credential, sending to the ECSP a request for an updated access credential;
receiving the updated access credential from the ECSP in response to the request, wherein the updated access credential includes or is based on one or more of the following: the indication that the client is a legitimate client; and the client type associated with the client; and
providing the updated access credential to the server via a next-established connection, for authentication of the EEC.

38. The method of claim 33, wherein the server is an Edge Configuration Server (ECS) or an Edge Enabler Server (EES).

39. A user equipment (UE) comprising a client for an edge data network, the UE comprising:
communication interface circuitry configured to facilitate communication between the client and one or more servers of the edge data network; and
processing circuitry operably coupled to the communication interface circuitry, whereby the processing circuitry and communication interface circuitry are configured to perform the method of claim 33 for the client.

40. A non-transitory, computer-readable medium storing computer-executable instructions that, when executed by processing circuitry associated with a client for an edge data network, configure the client to perform the method of claim 33.

41. A server configured for operation in an edge data network, the server comprising:
communication interface circuitry configured to communicate with one or more clients for the edge data network; and
processing circuitry operably coupled to the communication interface circuitry, wherein the processing circuitry and the communication interface circuitry are configured to:
establish a first connection with a client of the edge data network based on transport layer security (TLS);
provide a server certificate to the client, via the first connection, for authentication of the server; and
authenticate the client based on an initial access credential received from the client via the first connection, wherein the initial access credential includes or is based on one or more of the following: an indication that the client is a legitimate client; a client type associated with the client; and
an identifier of the client.

42. The server of claim 41, wherein:
the processing circuitry and the communication interface circuitry are further configured to, after authentication of the client based on the initial access credential, send a second access credential to the client via the first connection; and
the second access credential includes or is based on one or more of the following: the indication that the client is a legitimate client; the client type associated with the client; and an identifier of the client.

43. The server of claim 42, wherein the processing circuitry and the communication interface circuitry are further configured to:
establish a second connection with the client based on TLS;
provide the server certificate to the client, via the second connection, for authentication of the server; and
authenticate the client based on the second access credential received from the client via the second connection.

44. The server of claim 43, wherein:
the processing circuitry and the communication interface circuitry are further configured to, after authentication of the client based on the second access credential, selectively send a third access credential to the client via the second connection; and
the third access credential includes or is based on one or more of the following: the indication that the client is a legitimate client; the client type associated with the client; and the identifier of the client.

45. The server of claim 44, wherein the processing circuitry and the communication interface circuitry are configured to selectively send the third access credential based on:
comparing a duration of validity of the second access credential to a predetermined threshold;
sending the third access credential when the duration of validity is less than the predetermined threshold; and
refraining from sending the third access credential when the duration of validity is not less than the predetermined threshold.

46. The server of claim 41, wherein:
the initial access credential is obtained by the client from a credential provider other than the server; and
the processing circuitry and the communication interface circuitry are configured to authenticate the client based on the initial access credential based on:
validating the initial access credential based on one of the following: a certificate of the credential provider, a public key of the credential provider, or contacting the credential provider; and
verifying one or more of the following based on the initial access credential:
that the client is a legitimate client, and
that the client type associated with the client is a legitimate client type.

47. The server of claim 41, wherein:
the processing circuitry and the communication interface circuitry are further configured to, after expiration of at least the initial access credential, authenticate the client based on an updated access credential received from the client; and
the updated access credential includes or is based on one or more of the following: an indication that the client is a legitimate client, and a client type associated with the client.

48. The server of claim 47, wherein the processing circuitry and the communication interface circuitry are further configured to authorize the client to access the server based on at least one of the following: the initial access credential; and the updated access credential.

49. The server of claim 47, wherein one or more of the following applies:
the client is an Edge Enabler Client (EEC) and the initial access credential and the updated access credential are obtained by the EEC from an edge computing service provider (ECSP) associated with the EEC; and
the server is an Edge Configuration Server (ECS) or an Edge Enabler Server (EES).

50. A method for a credential provider in an edge data network, the method comprising:
providing an initial access credential for a server in the edge data network, to a client in the edge data network before the client accesses the server;
receiving from the client a request for an updated access credential for the server; and
sending the updated access credential to the client in response to the request,
wherein the initial access credential and the updated access credential include or are based on one or more of the following: an indication that the client is a legitimate client; and a client type associated with the client.

51. The method of claim 50, wherein at least one of the initial access credential and the updated access credential also includes or is further based on an identifier of the client.

52. The method of claim 50, wherein the client is an Edge Enabler Client (EEC) and the credential provider is an edge computing service provider (ECSP) associated with the EEC.

53. A non-transitory, computer-readable medium storing computer-executable instructions that, when executed by processing circuitry of a credential provider associated with an edge data network, configure the credential provider to perform the method of claim 50.

54. A credential provider associated with an edge data network, the credential provider comprising:
communication interface circuitry configured to communicate with one or more clients in the edge data network; and
processing circuitry operably coupled to the communication interface circuitry, wherein the processing circuitry and the communication interface circuitry are configured to:
provide an initial access credential for a server in the edge data network, to a client in the edge data network before the client accesses the server;
receive from the client a request for an updated access credential for the server; and
send the updated access credential to the client in response to the request,
wherein the initial access credential and the updated access credential include or are based on one or more of the following: an indication that the client is a legitimate client; and a client type associated with the client.
